(19) United States
(12) Patent Application Publication
(10) Pub. No.: US 2012/0163947 A1
(43) Pub. Date: Jun. 28, 2012

(54) VARIABLE SPEED SWEEP SYSTEM

(75) Inventors: Matthew R. Koch, Clear Lake, IA (US); Randal L. Marcks, St. Ansgar, IA (US); Charles E. Sukup, Dougherty, IA (US)

(73) Assignee: SUKUP MANUFACTURING COMPANY, Sheffield, IA (US)

(21) Appl. No.: 12/976,615

(22) Filed: Dec. 22, 2010

(51) Int. Cl. B65G 65/46

(52) U.S. Cl. 414/307

(57) ABSTRACT

A sweep control system having a sweep auger rotationally mounted about a central axis of a center sump and operatively connected to pusher motor(s). A sensor measures the load on the sweep auger and sends a signal to the controller. The controller compares the detected load to a predetermined load and sends a signal to a variable speed drive based on the comparison. The variable speed drive is connected to the pusher motor(s) and adjusts the speed of the pusher motor(s) based upon the received signal.

### BACKGROUND OF THE INVENTION

This invention is directed toward a sweep system, and more particularly, a system that varies the forward progression of a sweep auger about the axis of a grain bin to maintain a relatively constant load on said auger.

Sweep auger systems are well-known in the art for use in removing material from a bin. Typically, the sweep auger rotates about a central axis to draw grain from a bin floor to a central opening. As material flows through the central opening, it is transported and discharged by a take away auger. At certain times, the sweep auger is experiencing different loads which not only affect the efficiency of the discharge of material, but also negatively impact the life of motors and augers. In addition, it is desirable, for safety reasons, to eliminate the need for a person to enter the bin to repair, uncover or replace motors and/or augers.

In an attempt to improve upon this situation, as disclosed in U.S. Publ. No. 2005/0263372 by Hollander, a feedback loop was disclosed where the motors driving the sweep auger were turned on and off based upon the amperage reading of the sweep auger motor. This approach was still hard on motors, augers, bearings, belts etc. and in changing between ON and OFF states led to low electrical efficiency. Also, sweep augers can become buried by grain requiring individuals to enter the bin creating a safety hazard. As a result, a need exists in the art for a sweep control system that addresses these deficiencies.

An objective of the present invention is to provide a sweep control system that varies the speed (forward progress) of the sweep auger as the sweep auger moves around the bin.

Another objective of the present invention is to provide a sweep control system that maintains a longer operational life of motors and augers and reduces maintenance on pulleys and belts.

A still further objective of the present invention is to provide a sweep control system that is more efficient and effective in operation.

Another objective of the present invention is to provide a sweep control device where an individual need not enter the bin during unloading.

These and other objectives will be apparent to one of ordinary skill in the art based upon the following written disclosure, drawings, and claims.

### BRIEF SUMMARY OF THE INVENTION

A sweep control system having a sweep auger rotationally mounted about a central axis of a center sump and operatively connected to sweep motors. A sensor (i.e. a current transducer) measures load consumption on the sweep auger and sends a signal to the controller. The controller compares the detected load to a predetermined load and sends a signal to a variable speed drive on the tractor/pusher motor(s) based on the comparison. The variable speed drive is connected to the pusher motor(s) and adjusts the speed of the motors based upon the received signal, and thus, the forward progress of the sweep auger. The pusher motors may also be reversed.

### BRIEF DESCRIPTION OF THE DRAWINGS

FIG. 1 is a side sectional view of a sweep control system; and

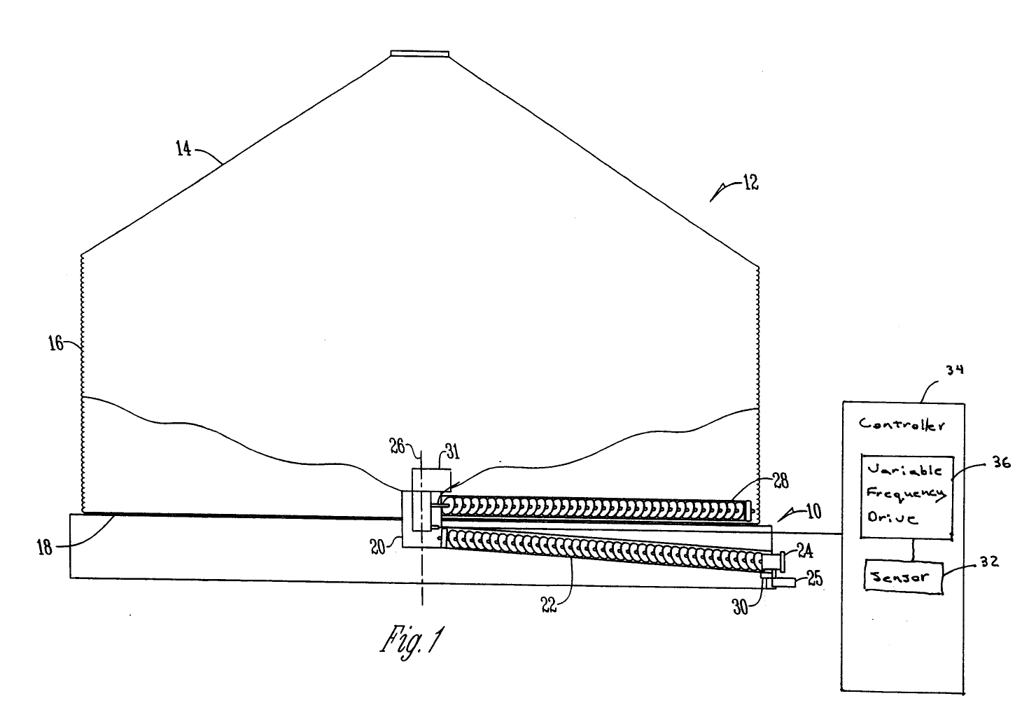

FIG. 2 is a top plan view of a sweep control system.

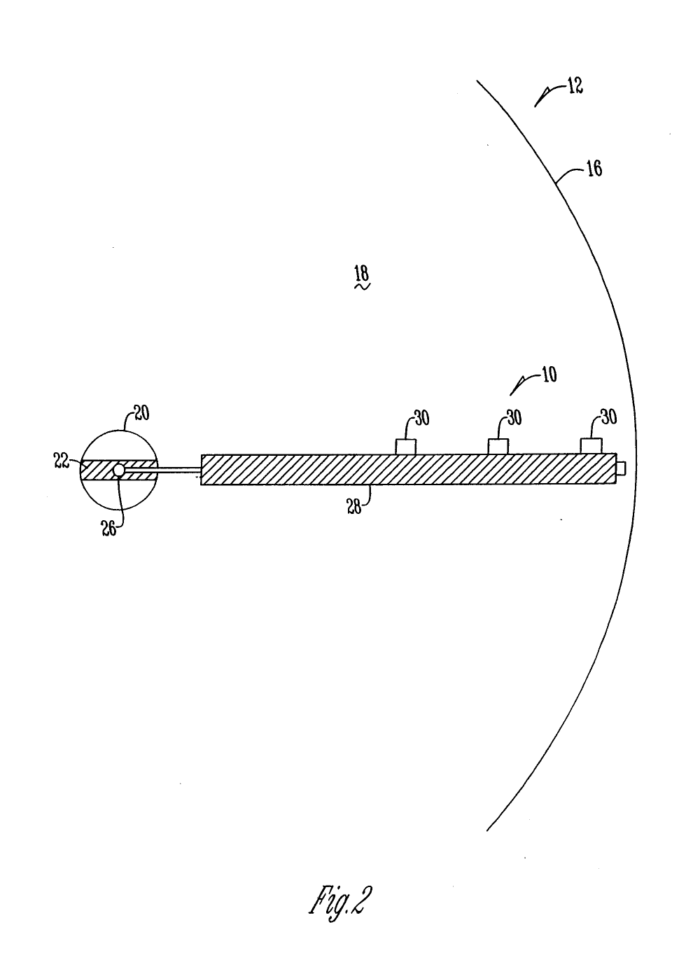

### DETAILED DESCRIPTION OF THE PREFERRED EMBODIMENT

Referring to the Figures, the variable speed grain sweep system 10 is used in a conventional grain bin 12 having a roof 14, sidewall 16, and floor 18. The floor 18 has a center sump or opening 20 used for the removal of material from the bin 12. The center sump 20 leads to an under-floor or take away conveyor/auger 22 that has a discharge 24. The auger 22 is driven by an external motor 25 adjacent the discharge 24.

Within the bin 12, extending radially from a central axis 26 is a sweep auger 28. The sweep auger 28 is operatively connected to pusher motor(s) 30 that, when driven, rotate the sweep auger 28 about the central axis and around the bin floor 18 to draw grain from the floor 18 to the center sump 20 for discharge.

Connected to the sweep auger motor 31 is a sensor 32 such as a current transducer that monitors the sweep auger motor's 31 amperage and converts the amperage into a low-voltage, dc reference signal. The sensor 32 is connected to a controller 34 that receives the signal transmitted from sensor 32.

A variable frequency drive 36 is connected to the pusher motor(s) 30 and the controller 34. Based on the load (i.e., amperage) detected on the sweep auger 28, the variable frequency drive 36 adjusts the speed of the pusher motor(s) 30 which adjust the rate of forward movement of the sweep auger 28 about the central axis 26 to regulate the flow of material along the auger.

In operation, the system is activated such that the sweep auger 28 rotates about the central axis 26 to deliver material from the bin floor 18 to the center sump 20. Material flows from the center sump 20 to the take away auger/conveyor 22 where the material is transported to the discharge 24. The desired load (i.e., amperage) is input into the controller 34 to set a desired flow of material to the take away auger/conveyor 22. The flow rate can be adjusted up or down by an operator based upon a visual inspection of material at center sump 20. For a higher flow-rate, an operator would adjust for a higher load rate (up to sweep auger's maximum capacity) and vice versa for a lower flow-rate.

As material is moved to the center sump 20, the sensor 32 monitors the load on the sweep auger motor 31 and transmits the detected load to the controller 34. The controller 34 compares the detected load to the desired load and then sends a signal to the variable frequency drive 36. If the detected load is higher than the desired load, a signal is sent which causes the variable frequency drive 36 to slow down the pusher motor(s) 30, which slows forward movement of the sweep auger 28, and slows the flow of material to the center sump 20. If the detected load is lower than the desired load, then the signal is sent which causes the variable frequency drive 36 to increase the speed of the pusher motor(s) 30, which causes the forward movement of the sweep auger 28 to increase the flow of material to the center sump 20. If the detected load is equal to the desired load, a signal is sent to the variable frequency drive causing the speed of the pusher motor(s) 30 to remain the same.

The system may also allow for reverse movement of the pusher motor(s). In one example, this would involve the operator inputting a command such that the controller receives a signal and sends a signal to the pusher motor(s) 30 that reverses the direction the sweep auger moves. Alternatively, the controller 34 sends a signal to reverse the direction of movement of the pusher motor(s) 30 based upon the load on the sweep auger motor 31 and/or the rate of change of the load on the sweep auger system 31.

As a result, the load on the take away auger motor 31 remains relatively constant which results in a longer operating life for the augers and motors, reduced maintenance of the belts and pulleys, reduces stress on the unload system and reduces the need to enter the bin. Accordingly, a variable speed sweep system has been disclosed that at the very least meets all of the stated objectives.

What is claimed is:

1. A sweep control system, comprising:
a sweep auger rotationally mounted about a central axis of a center sump of a bin and operatively connected to at least one pusher motor;
a sensor mounted to a sweep auger and connected to a controller wherein the sensor detects a load placed upon the sweep auger; and
a variable speed drive, connected to the pusher motor(s) and the controller, that adjusts the speed of the pusher motor(s) based upon the detected load placed upon the sweep auger motor.

2. A sweep control system of claim 1 wherein based on a signal from the controller the pusher motors move in a reverse direction.

3. A sweep control system of claim 1 wherein pusher motor(s) are reversed based upon the rate of change of the load detected on the sweep auger motor.
